(19) United States
(12) Patent Application Publication
(10) Pub. No.: US 2026/0245822 A1
(43) Pub. Date: Aug. 20, 2026

(54) FUSE, AND METHOD FOR MANUFACTURING A FUSE

(71) Applicant: SIBA Fuses GmbH, Lünen (DE)

(72) Inventor: Andreas Grünig, Lünen (DE)

(73) Assignee: SIBA Fuses GmbH, Lünen (DE)

(21) Appl. No.: 19/162,533

(22) PCT Filed: Jan. 8, 2024
(86) PCT No.: PCT/EP2024/050280

§ 371 Date: Sep. 5, 2025

(30) Foreign Application Priority Data
Mar. 9, 2023 (DE) 10 2023 000 890.7

(51) Int. Cl. H01H 85/055; H01H 85/165; H01H 85/38

(52) U.S. Cl. CPC H01H 85/055; H01H 85/165; H01H 85/38

(57) ABSTRACT

A fuse has an insulating body open at the end face, a fusible conductor arranged in the insulating body, an auxiliary cap electrically contacting the fusible conductor and at least partly covering the end face of the insulating body, and an outer cap allocated to the auxiliary cap and at least partly covering same and electrically contacting the auxiliary cap. The auxiliary cap has a receptacle projecting into the interior of the insulating body and having an opening projecting into the interior of the insulating body, through which opening the end region of the fusible conductor is guided; the end region of the fusible conductor is integrally connected in an electrically contacting manner to the auxiliary cap via a connection means arranged in the receptacle; and the outer cap covers the auxiliary cap such that the connection means is caught and/or encapsulated between the auxiliary cap and the outer cap.

### CROSS-REFERENCE TO RELATED APPLICATIONS

The present application is the U.S. national stage application of international application PCT/EP2024/050280, filed Jan. 8, 2024, which international application was published in the German language on Sep. 12, 2024, as International Publication WO 2024/183962A1 . The international application claims priority to German Patent Application No. 10 2023 000 890.7, filed Mar. 9, 2023. The international and German applications are hereby incorporated by reference herein.

### FIELD

The present invention relates to a fuse, in particular an SMD fuse and/or a device protection fuse, with an insulating body open at the front, at least one fusible conductor arranged in the insulating body and at least one auxiliary cap connected to the fusible conductor in electrical contact for covering at least part of the front side of the insulating body, and an outer cap assigned to the auxiliary cap, covering at least part of the latter and connected to the auxiliary cap in electrical contact. Furthermore, the present invention relates to a method for manufacturing a fuse of the aforementioned type.

### BACKGROUND

A fuse and/or device protection fuse within the meaning of the present invention is also referred to in the prior art as a so-called “fuse insert” which can interact with a fuse holder. The fuse insert can be inserted into the fuse holder.

If necessary, the fuse and/or fuse insert is filled with an extinguishing agent, in particular sand, granulate and/or glass beads in particular, wherein the extinguishing agent is arranged in the insulating body. The insulating body can be designed as an insulating tube. In practice, the fusible conductor is inserted axially into the insulating body. The electrical contact between the fusible conductor and the outer contact caps attached to the insulating housing is established by a soldered connection. In addition, the soldered connection also connects the outer contact caps to the insulating body in a material-locking manner.

The fusible conductor is designed to carry the full load current during operation and, in particular, to interrupt an overload current and/or short-circuit current as quickly as possible.

SMD fuses are fuse inserts that can be mounted on printed circuit board surfaces (SMD-Surface Mounted Device). SMD fuses therefore belong to the technical field of surface mounting technology (SMT-Surface Mounted Technology). In surface mounting technology, printed circuit boards are generally used as the surfaces to be assembled. SMD fuses in particular are standardised in terms of their dimensions and electrical behaviour—see DIN EN 60127-4 VDE 0820-4: 2013-12 (as of March 2023) in this context.

A disadvantage of the fuses known from the prior art is that, in some fuses, the fusible conductor shifts and/or moves within the insulating body during fuse manufacture, after the fusible conductor has been inserted into the insulating body. Ultimately, the fusible conductor does not remain in its intended mounting position. During installation of the fuse, the fusible conductor may therefore come into contact with and/or strike the inner wall of the insulating body. Such displacement of the fusible conductor in the insulating body changes the switching behaviour of the entire fuse and, in particular, no longer corresponds to the specified values. This is extremely disadvantageous, as each fuse is designed for specific values and is used in accordance with these values. Any deviation from the specified values must therefore be avoided at all costs.

Fuses with “displaced” fusible conductors can be rejected after manufacture by means of visual inspection procedures. However, this procedure is relatively complex and costly, particularly as each individual fuse must be visually inspected. Furthermore, due to the particularly opaque insulating body, this visual inspection can only be carried out as long as the outer contact caps have not yet been fitted. However, if the fusible conductor shifts after or during the fitting of the outer contact caps, this can no longer be detected visually.

Another disadvantage of the fuses known from the prior art and/or of the method for manufacturing fuses known from the prior art is that the connection of the fusible conductor to the solder joint for electrical contacting of the outer contact caps is often insufficient for a permanent electrical connection. For electrical contact between the fusible conductor and the outer contact cap, it is particularly necessary to form a so-called “solder ball”—a ball made of the solder material—which, however, does not always ensure a sufficient connection. As a result, the solder or solder material may migrate into the space between the outer contact cap and the insulating body, leaving insufficient solder for an adequate electrical connection between the fusible conductor and the outer contact caps.

### SUMMARY

The present invention is therefore intended to avoid or at least substantially reduce the aforementioned disadvantages of the prior art. In particular, the present invention aims to ensure that the fusible conductor is positioned securely and permanently in the insulating body.

According to the invention, the aforementioned object is solved by a fuse according to the claims.

The fuse according to the invention is designed in particular as an SMD fuse and/or device protection fuse. The fuse has an insulating body that is open at the front, i.e. open at both front sides. At least one fusible conductor, which may also be designed as a fusible wire, is arranged in the insulating body. In addition, the fuse comprises at least one auxiliary cap which is electrically connected to the fusible conductor. The auxiliary cap is designed to cover at least part of the front side of the insulating body. In addition, the auxiliary cap is assigned an outer cap which covers the auxiliary cap at least in part, preferably completely, and is electrically connected to the auxiliary cap.

It is understood that a further auxiliary cap and/or a further outer cap may also be provided. In particular, the insulating body is first covered on both front sides with an auxiliary cap and then with an outer cap. However, the present invention is not limited to two auxiliary caps and/or two outer caps and can already be realised with one auxiliary cap and/or one outer cap.

According to the invention, the auxiliary cap is designed to have a receptacle projecting into the interior of the insulating body with a through-opening projecting into the interior of the insulating body. The end region of the fusible conductor can be passed through the through-opening and/or, in the finished state of the fuse, the fusible conductor is passed through the through-opening with its end region.

The end region of the fusible conductor is electrically connected to the auxiliary cap via a material-locking connecting means, in particular a lead-free connecting means, arranged in the receptacle. The outer cap covers the auxiliary cap in such a way that the connecting means is trapped and/or encapsulated between the auxiliary cap and the outer cap.

The connecting means is arranged in the receptacle in such a way that it cannot enter the interior of the insulating body and/or escape via the outer cap. It is particularly preferred that, even if the connecting means melts and/or liquefies at a later stage, penetration and/or escape of the connecting means into the interior of the insulating body can be prevented at least substantially reliably. Consequently, the connecting means is encapsulated in the receptacle.

In this context, it is understood that the receptacle may be partially or completely filled with the connecting means. Ultimately, the connecting means is arranged in the receptacle in such a way that the fusible conductor can be securely and permanently fixed in place.

Accordingly, the invention provides that the auxiliary cap, by means of the receptacle with the through-opening, provides a means of ensuring a simplified arrangement of the connecting means for permanent contact with the fusible conductor.

The connecting means may have different shapes and/or structures. For example, it may be provided that the connecting means is liquefied and/or melted for a material-locking connection with the fusible conductor. In particular, solder may be provided as the connecting means. However, it may also be provided that the connecting means can be provided as a sheath for the fusible conductor. This sheath is then connected to the auxiliary cap in a material-locking and/or electrically contacting manner.

The connecting means is also preferably connected to the auxiliary cap and to the end region of the fusible conductor in a material-locking manner. However, the connecting means may also be connected to the auxiliary cap in other ways, in particular in a form-locking and/or friction-locking manner. In particular, it is intended that the connecting means ultimately ensures the electrical connection between the fusible conductor and the auxiliary cap and also ensures the positioning of the fusible conductor.

The connecting means ensures permanent electrical contact with the fusible conductor, wherein the connecting means can also ensure that the fusible conductor is positioned stably in the insulating body. The receptacle therefore represents a possible arrangement for the connecting means and also allows the connecting means to remain only in a pre-determined and defined area in the fuse. This prevents the connecting means from entering the interior of the insulating body, for example.

Although the receptacle has a through-opening, the auxiliary cap is particularly favourably designed so that the connecting means cannot escape into the interior of the insulating body—and thus beyond the through-opening into the interior of the insulating body—from the connecting means. In particular, the connecting means does not extend beyond the through-opening into the interior of the insulating body, so that the through-opening, despite being designed as an opening, acts as a barrier for the connecting means. The auxiliary cap and the receptacle are designed in such a way that the connecting means cannot penetrate into the interior of the insulating body. The through-opening therefore serves to guide the end region of the fusible conductor, but not to guide the connecting means. The secure fixing of the fusible conductor, which is ultimately achieved in particular by the connecting means, reliably prevents the fusible conductor from leaning against the inner wall of the insulating body. The end section of the fusible conductor can be fixed firmly and permanently by the connecting means, and this fixation can also withstand high stresses.

In a preferred embodiment, the fusible conductor is designed to end within the receptacle inside the insulating body and/or to be arranged without contact with the outer cap and/or the auxiliary cap. It is particularly preferred that the fusible conductor does not directly adjoin a wall of the outer cap, the auxiliary cap and/or the insulating body, wherein the electrical contact of the fusible conductor to the outer cap can ultimately be ensured by the arrangement of the connecting means in the auxiliary cap.

The aforementioned formation ensures that the fuse can be used properly and safely over a long period of time. High scrap rates during production of the fuse can be avoided in particular because there is no need for precise adjustment of the contact between the fusible conductor and the auxiliary cap or the outer cap; instead, electrical contact can be ensured reliably and permanently via the connecting means arranged in the holder.

Preferably, the length of the fusible conductor is less than or equal to the length of the insulating body. The fusible conductor can be arranged in the insulating body in a straight, preferably elongated state. In principle, however, it would also be possible in further embodiments for the fusible conductor to be provided in the insulating body, for example wound on a winding body. In this case, the length of the fusible conductor would be greater than the length of the insulating body, but this is not essential. A shorter length of the fusible conductor ensures that less material is used for the fusible conductor, which makes sense for economic reasons.

It is particularly preferred that the end region of the fusible conductor is completely enclosed by the connecting means.

In further embodiments, at least a section of the end region may also protrude beyond the connecting means, in particular so that not the entire end region of the fusible conductor is enclosed by the connecting means.

Complete enclosure of the end region of the fusible conductor by the connecting means can ensure that the fusible conductor is securely fixed and, in addition, long-term electrical contact of the end region of the fusible conductor can be ensured. The connecting means therefore ensures that the fusible conductor is fixed in the insulating body.

In a further preferred embodiment of the invention, the connecting means is arranged exclusively in the area of the receptacle. The receptacle ultimately represents the area of the fuse that can be used for the connecting means. The connecting means then has the function of fixing the fusible conductor and connecting it electrically to the outer cap via the auxiliary cap. For this purpose, it is not necessary for the connecting means to be arranged outside the receptacle, so that, for reasons of material economy alone, it makes sense to arrange it only in the receptacle.

The through-opening preferably has an opening width of at least 0.1 mm. The opening width of the through-opening is particularly preferably between 0.1 mm and 6 mm, preferably between 0.5 mm and 5 mm, more preferably between 0.8 mm and 2.4 mm and especially between 1.1 mm and 1.5 mm. Through-opening widths in the aforementioned range enable, on the one hand, the end region of the fusible conductor to pass through the through-opening and, on the other hand, prevent the connecting means—even in a liquefied state—from escaping into the interior of the insulating body via the through-opening.

In a further embodiment, it is particularly preferred that the opening is designed as a V-shaped trough and/or as a truncated cone-shaped recess. A truncated cone-shaped recess or a recess that is at least essentially truncated cone-shaped can also be regarded as a trough. A truncated cone-shaped recess allows the connecting means to be inserted and arranged in the receptacle with relative ease. Preferably, the opening angle (i.e. in particular the double angle between the generatrix and the cone axis) of the recess, which is preferably designed as a truncated cone, is between 10° and 100°, preferably between 20° and 90°, and more preferably between 50° and 70°. This opening angle can thus ensure a trough that widens towards the front side of the insulating body. Such a trough shape offers the advantage that encapsulation of the fastener can be achieved relatively easily, since the trough-opening tapers towards the interior of the insulating body, so that the fastener is ultimately encapsulated in the receptacle.

In a further embodiment, it is particularly preferred that the connecting means located in the receptacle rests directly against the inner wall of the outer cap facing the interior of the insulating body.

In alternative embodiments, it may be provided that the connecting means is only indirectly arranged on the outer cap and that the outer cap is electrically contacted via the auxiliary cap.

Direct contact with the outer cap has the advantage that the connecting means can make direct electrical contact with the outer cap, thus ensuring that, when current is flowing, electrical contact is established directly between the outer cap, the connecting means and the fusible conductor and indirectly via the auxiliary cap, so that ultimately there is “double protection”.

In addition, the receptacle can be filled at least substantially completely with the connecting means. Alternatively or additionally, it may be provided that at least 20%, preferably at least 30%, more preferably at least 40%, in particular between 30% and 80%, of the volume of the receptacle is filled with the connecting means, in particular solder. Partial filling of the receptacle offers the advantage, particularly when using connecting means with high material costs, that a small amount of the connecting means can be provided. For example, gold-containing connecting means can also be used.

In a further preferred embodiment, the outer cap is connected to the auxiliary cap by a press fit. Alternatively or additionally, the outer cap may be connected to the auxiliary cap by at least one crimp connection, in particular by four crimp connections. A connection of the aforementioned type enables the outer cap to be firmly adapted to the auxiliary cap, in particular without the need for an additional adhesive connection or the like. Screw connections, which could otherwise damage the insulating housing, can also be avoided. The press fit and/or crimp connection between the auxiliary cap and the outer cap ensures a stable, in particular form-fitting and/or friction-locking connection, which in particular also withstands long-term stresses when used as a fuse.

Preferably, the auxiliary cap has a sheath surface surrounding the wall of the insulating body. The auxiliary body can in particular be connected to the wall of the insulating body in a friction-locking manner. Alternatively or additionally, the sheath surface of the auxiliary cap may have at least one, preferably circumferential, end-protruding locking leg which is engaged by the outer cap. The locking leg can therefore serve to improve the connection and attachment of the outer cap. As a result, locking is particularly advantageous. The sheath surface can preferably be designed in one piece. The locking leg is particularly preferably designed to be circumferential around the insulating body and protruding from the insulating body.

In addition, in a further preferred embodiment, the outer cap can be designed to completely cover the front side of the insulating body. The outer cap can thus protect the interior of the insulating body from external influences and thus ensure its use as an SMD fuse. The outer cap preferably has an outer sheath surface which at least indirectly surrounds the wall of the insulating body and is preferably connected in a friction-locking manner to the sheath surface of the inner auxiliary cap and at least indirectly, in particular in a friction-locking manner, to the wall of the insulating body. It is particularly preferred that the outer sheath surface of the outer cap is locked with the locking leg of the auxiliary cap. The outer sheath surface of the outer cap can, in particular, at least substantially completely cover and/or conceal the sheath surface of the auxiliary cap, so that the auxiliary cap can be covered from the outside by the outer cap. The outer sheath surface and the inner sheath surface of the auxiliary cap can be connected to each other in electrical contact, preferably by lying at least substantially directly against each other.

Preferably, the connecting means can comprise and/or consist of solder and/or an electrically conductive adhesive, in particular silver conductive adhesive, as a material. Alternatively or additionally, the connecting means may be designed as a conductive sheath surrounding the end region of the fusible conductor, in particular a tin sheath. In this design, it is understood that the tin sheath in particular can be regarded as a connecting means which can surround the end region of the fusible conductor, which in turn may be a wire. The tin coating can then be designed to connect the fusible conductor wire and the auxiliary cap.

The connecting means can be used in different states or forms for connection with the fusible conductor. For example, the connecting material, in particular the solder, can be in wire form, as solder paste, as a pellet or as a moulded part before fusion. Alternatively or additionally, the solder can be lead-free. A lead-free design is particularly advantageous with regard to the standards and specifications to be complied with. Ultimately, different forms of the connecting means can be used to electrically connect the end area of the fusible conductor to the auxiliary cap and/or the outer cap. However, the use of the connecting means as solder, which can be provided in different forms, is particularly preferred. All connecting means have in common that electrical contact between the fusible conductor and a fixing connection of the fusible conductor to the auxiliary cap can be ensured. Various materials known in practice can be used as solder. In particular, gold alloys can also be used as solder.

In a further preferred embodiment of the invention, the auxiliary cap is provided with a bridging area connecting the outer surface to the receptacle. The bridging area may in particular rest at least in some areas on the front side of the wall of the insulating body and preferably protrude from this wall. Alternatively or additionally, the bridging area may be provided so that it protrudes circumferentially opposite the wall of the insulating body. The bridging area can thus, in combination with the design of the recess, ensure a bridge between the outer surface and the recess. The bridging area can also serve to bear against the outer cap and thus to make electrical contact with the outer cap. The bridging area thus ensures that different shapes for the recess can be provided independently of the design of the sheath surface.

Preferably, the receptacle opposite the through-opening projecting into the interior of the insulating body may have a further opening. The further opening may preferably be at least substantially circular. In particular, the area of the further opening spans between 30% and 90%, preferably between 50% and 80%, and more preferably between 60% and 75% of the area of the open-front side of the insulating body. The through-opening can form the cover surface (i.e. the cut surface) and the further opening can form the base surface of the recess, which is preferably designed as a truncated cone. The area of the through-opening can be smaller than the area of the further opening. This allows the fusible conductor to be inserted into the interior first through the further opening and then through the through-opening. A through sheath surface can then be arranged between the through-opening and the further opening, to which the end region of the fusible conductor can adjoin. The through can thus be formed and preferably limited by the through sheath surface, the through-opening and the further opening.

In particular, the interior of the insulating body is at least partially filled with an extinguishing agent, in particular extinguishing sand. The extinguishing agent may be designed specifically for extinguishing an electric arc.

The extinguishing agent may in particular comprise extinguishing sand with a preferably defined grain distribution, which is preferably suitable for use in safety applications. In addition, coloured sands, sand and/or ceramic chips and/or glass beads can also be used as extinguishing agents.

Other materials can also be used as extinguishing agents. However, the extinguishing agent is designed in particular to extinguish the arc in the event of activation. Suitable materials can be used as extinguishing agents for this purpose.

The insulating body can be designed in particular as an insulating tube. The fusible conductor can then preferably be inserted axially into the insulating body via the further opening and the through-opening.

If extinguishing sand is intended as the extinguishing agent, quartz sand is particularly preferred. As explained above, the extinguishing agent enables an electric arc to be extinguished when the fuse is triggered, thereby increasing the safety and/or switching capacity and/or switching performance of the entire fuse.

In addition, the fusible conductor can be provided with constrictions through which a faster or slower overload and/or short-circuit behaviour can be set. The constrictions can then be designed in particular as cross-sectional narrowings.

In addition, the insulating body can comprise an electrically insulating material such as glass and/or ceramic and/or consist thereof.

Preferably, the fusible conductor can be arranged completely within the insulating body, wherein external contact with the fusible conductor can be made via the outer caps. This can ensure a simple arrangement of an SMD fuse on a printed circuit board.

In particular, the fusible conductor can be arranged centrally within the insulating body, which is particularly advantageous for the behaviour of the fuse.

Alternatively or additionally, the insulating body may be provided to comprise and/or consist of plastic material. In particular, an electrically insulating material is provided as the material for the insulating body.

Preferably, a further auxiliary cap connected to the fusible conductor is provided for covering at least part of the further front side of the insulating body, and a further outer cap associated with the further auxiliary cap and covering the latter at least in part, preferably completely, and electrically connected to the further auxiliary cap is provided.

In this context, it is understood that, with regard to embodiments of the further auxiliary cap and/or the further outer cap, reference may be made to the aforementioned description of the auxiliary cap and/or outer cap, since the further auxiliary cap and/or the further outer cap can also be provided with the features discussed above.

Ultimately, it is understood that two auxiliary caps and two outer caps may also be provided in accordance with the aforementioned design.

It is particularly preferred that the auxiliary cap and the additional auxiliary cap, as well as the outer cap and the additional outer cap, are each designed to be at least substantially identical in construction. However, the auxiliary cap and the further auxiliary cap and/or the outer cap and the further outer cap may also be designed differently from each other. In this case, the auxiliary cap and the outer cap as well as the further auxiliary cap and the further outer cap are preferably matched to each other so that electrical contact of the fusible conductor via the respective outer cap can be ensured. Even if the auxiliary cap and the further auxiliary cap and/or the outer cap and the further outer cap are designed differently, it goes without saying that reference may also be made to the above statement in this context, as these explanations are equally applicable to the further auxiliary cap and the further outer cap.

Furthermore, the present invention relates to a method for manufacturing a fuse according to one of the aforementioned embodiments, wherein the method comprises the following steps, which are preferably carried out in sequence:
A) Provision of an insulating body, at least one auxiliary cap, at least one outer cap and at least one fusible conductor;
B) Placing the auxiliary cap on one end of the insulating body;
C) Optional: Attaching an additional auxiliary cap to another end of the insulating body;
D) Inserting the fusible conductor into the interior of the insulating body, in particular via the through-opening of the receptacle of the auxiliary cap;
E) Connecting the auxiliary cap to the fusible conductor by placing the connecting means in the receptacle of the auxiliary cap to electrically connect the auxiliary cap to the fusible conductor;
F) Optional: Rotation of the insulating body, in particular by 100° to 200°, preferably by approximately 180°;
G) Optional: Introduce extinguishing agent, preferably via the front side that is not yet covered and/or via the additional opening of the additional auxiliary cap that is not yet filled with connecting means.
H) Covering the auxiliary cap with the outer cap for electrical contact.

In connection with the method according to the invention, reference may be made to the aforementioned preferred embodiments of the fuse according to the invention and to the advantages of the fuse, which apply equally to the method according to the invention, in particular without the need for further explicit mention. At the same time, the process features and advantages described below also apply in the same way to the fuse according to the invention described above. Accordingly, reference is made to the following and preceding statements to avoid unnecessary repetition.

In a particularly preferred embodiment of the method according to the invention, it is provided that the further auxiliary cap is preferably connected to the fusible conductor after process step F and/or after process step G and/or H by means of the connecting means in the further receptacle of the further auxiliary cap for electrical connection of the further auxiliary cap to the fusible conductor.

In particular, the further auxiliary cap can be covered with the further outer cap for electronic contacting, preferably in a fixed manner.

In addition, the connecting means can be heated, in particular melted, after being arranged in the receptacle, so that an electrical connection and a firm fixation between the connecting means and the fusible conductor as well as between the fusible conductor and the auxiliary cap are obtained in a particularly preferred manner. In particular, the connecting means, which is preferably already arranged in the receptacle, is heated by means of a flame, resistance soldering, laser soldering, hot air and/or induction. The aforementioned methods for heating the connecting means have proven to be particularly advantageous and precise in tests carried out during the development of the invention in order to ensure a secure connection. Alternatively or additionally, the connecting means, in particular the solder, may be designed in wire form, as solder paste, as a pellet or as a moulded part before heating and/or melting.

Furthermore, it is understood that any intermediate intervals and individual values are included in the aforementioned intervals and range limits and are to be regarded as disclosed as essential to the invention, even if these intermediate intervals and individual values are not specifically stated.

### BRIEF DESCRIPTION OF THE DRAWINGS

Further features, advantages and possible applications of the present invention are apparent from the following description of embodiments with reference to the drawing and the drawing itself. All features described and/or depicted figuratively, either individually or in any combination, constitute the subject matter of the present invention, regardless of whether they are summarised in the claims or referred to therein.

It shows:

FIG. 1 is a schematic perspective view of a fuse according to the invention,

FIG. 2 is a schematic perspective sectional view of the fuse shown in FIG. 1,

FIG. 3 is another schematic cross-sectional view of the fuse shown in FIG. 1,

FIG. 4 is a schematic perspective view of the fuse shown in FIG. 1 without the outer cap,

FIG. 5 is a schematic perspective sectional view of the fuse shown in FIG. 4 without outer caps,

FIG. 6 is another schematic cross-sectional view of the fuse shown in FIG. 4 without outer caps,

FIG. 7 is a schematic perspective view of an auxiliary cap according to the invention,

FIG. 8 is a schematic perspective sectional view of the auxiliary cap shown in FIG. 7,

FIG. 9 is a further schematic sectional view of the auxiliary cap shown in FIG. 7 and

FIG. 10 is a schematic representation of a method according to the invention for manufacturing a fuse according to the invention.

### DETAILED DESCRIPTION

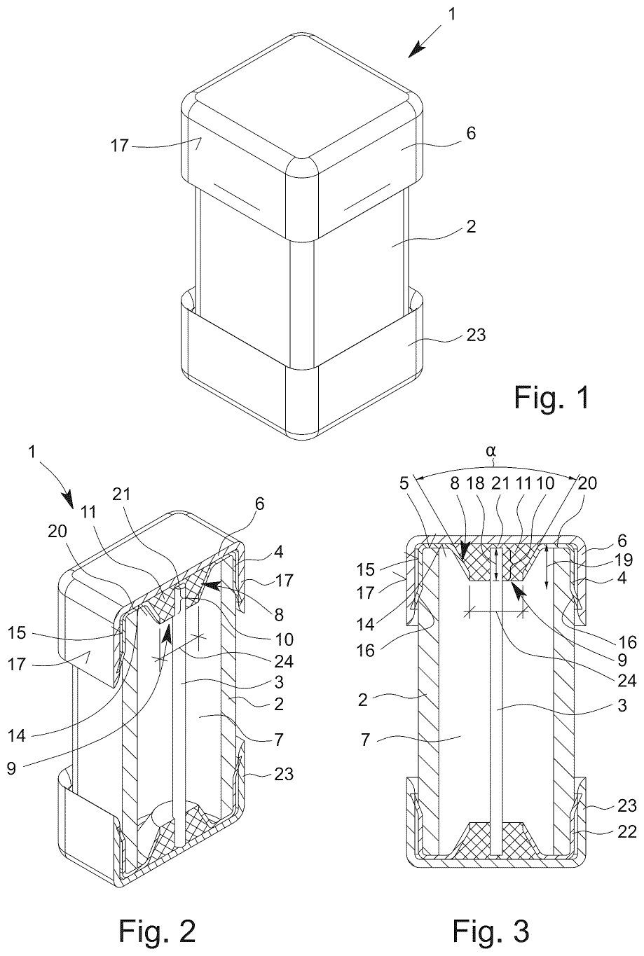

FIG. 1 shows a fuse 1, which may be designed in particular as an SMD fuse. Its use as an SMD fuse is not shown in detail.

FIGS. 2 and 3 show cross-sectional views of the fuse 1 shown in FIG. 1.

FIG. 2 illustrates that the fuse 1 has an insulating body 2 that is open at the front. In the embodiment shown in FIG. 2, the insulating body 2 is open at both front sides. FIG. 1 shows an insulating body 2 that is at least essentially cuboid in shape.

In further embodiments, different shapes can be used for this insulating body 2, for example a tubular design of the insulating body 2.

FIGS. 2 and 3 show that a fusible conductor 3 is arranged in the insulating body 2. The fusible conductor 3 can also be referred to as a fusible conductor wire. In addition, an auxiliary cap 4 is provided, which is electrically connected to the fusible conductor 3. In the embodiments shown in FIGS. 2 and 3, two auxiliary caps 4, 22 are provided, which are preferably identical in construction. It is not shown that only one auxiliary cap 4 can be used. The fuse 1 also comprises an outer cap 6. The outer cap 6 is assigned to the auxiliary cap 4 and covers and/or conceals the auxiliary cap 4 at least in some areas, preferably completely. The outer cap 6 is electrically connected to the auxiliary cap 4. In addition, the auxiliary cap 4 covers at least part of the front side 5 of the insulating body, as shown in FIG. 3.

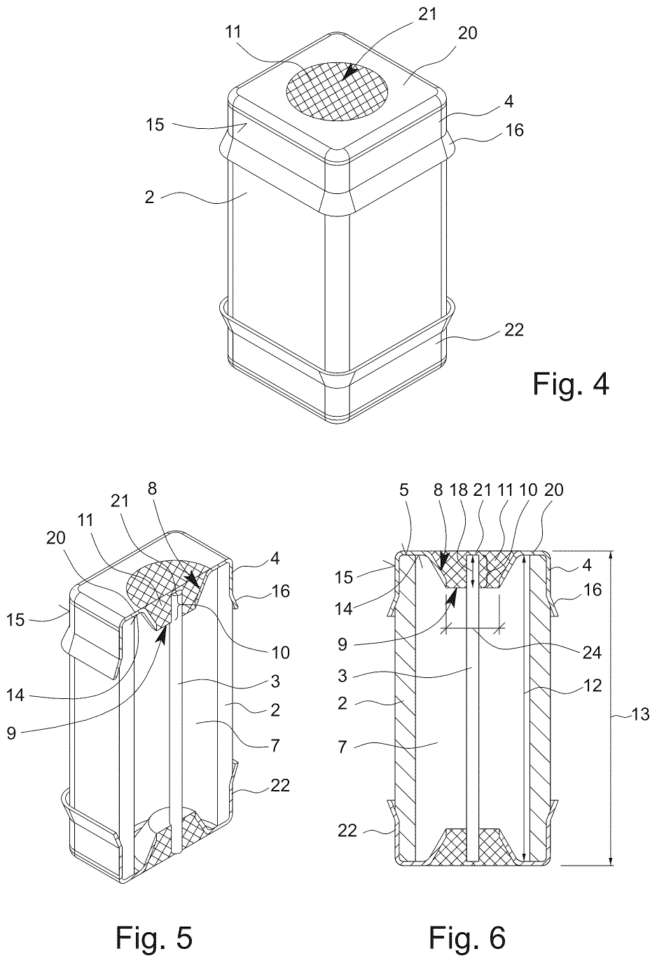

FIG. 4 shows the fuse shown in FIG. 1 without the outer caps 6. It goes without saying that two outer caps 6, 23 can also be used. In the embodiment shown, both outer caps 6, 23 are at least essentially identical in design. It is not shown that only one outer cap 6 can be provided.

FIGS. 5 and 6 show cross-sectional views of the fuse 1 shown in FIG. 4 without the outer caps 6.

FIG. 2 shows that the auxiliary cap 4 has a receptacle 8 projecting into the inside 7 of the insulating body 2 with a through-opening 9 projecting into the interior of the insulating body 2, through which the end region 10 of the fusible conductor 3 is passed.

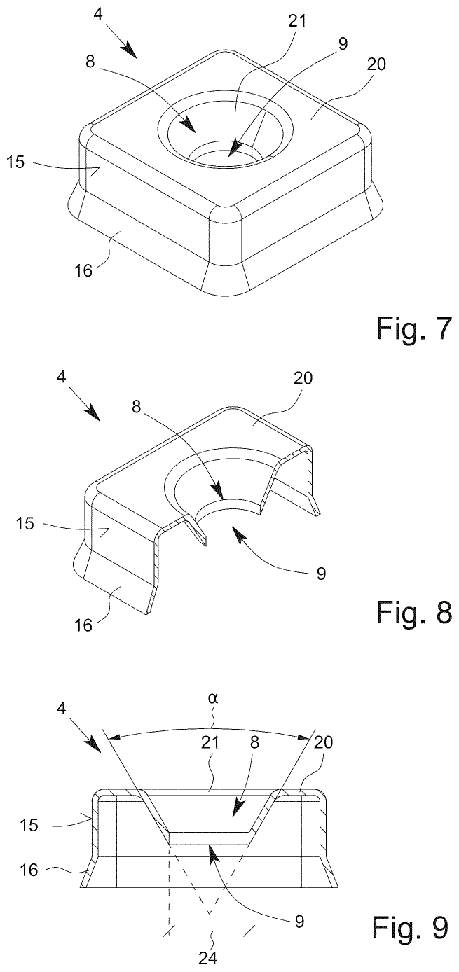

FIG. 3 again illustrates that the end region 10 of the fusible conductor 3 is electrically connected to the auxiliary cap 4 via a connecting means 11, in particular lead-free, arranged in the receptacle 8. The connecting means 11 is at least partially arranged in the receptacle 8. FIG. 2 shows that the receptacle 8 is at least substantially completely filled with the connecting means 11, although this is not absolutely necessary. The receptacle 8 without connecting means 11 is shown in FIG. 7. FIGS. 8 and 9 show cross-sectional views of the auxiliary cap 4 shown in FIG. 4.

FIG. 2, but also FIG. 3, illustrate that the outer cap 6 covers the auxiliary cap 4 in such a way that the connecting means 11 is trapped and/or encapsulated between the auxiliary cap 4 and the outer cap 6.

The connecting means 11 is arranged in the receptacle 8 in such a way that the connecting means 11 does not penetrate into the interior 7 of the insulating body 2, i.e. beyond the through-opening 9 of the receptacle 8. The through-opening 9 in particular forms a boundary for the connecting means 11. The receptacle 8 is accordingly shaped and/or designed such that encapsulation and/or trapping of the connecting means 11 in the receptacle 8 can be ensured.

The connecting means 11 is trapped and/or encapsulated in the receptacle 8 even when the fuse 1 is heated and, in particular, does not penetrate into the interior 7 of the insulating body 2 via the through-opening 9.

FIG. 2 shows that the fusible conductor 3 ends in the receptacle 8 inside the insulating body 2 and is also arranged so as not to come into contact with the outer cap 6 and the auxiliary cap 4. In further embodiments, it may also be provided that the fusible conductor 3 rests against and/or strikes the auxiliary cap 4, the outer cap 6 and/or the receptacle 8. Electrical contact of the fusible conductor 3 is ensured in the embodiment shown in FIG. 2 by means of the connecting means 11.

In the embodiment shown in FIG. 2, it is also provided that the length 12 of the fusible conductor 3 is less than or equal to the length 13 of the insulating body 2, as clearly illustrated in FIG. 6.

In further embodiments, it may also be provided that the length 12 of the fusible conductor 3 exceeds the length 13 of the insulating body 2, in particular if the fusible conductor 3 is provided wound in the insulating body 2. In the preferred and illustrated embodiment, an elongated fusible conductor 3 is provided. The fusible conductor 3 can have different shapes, so that the fusible conductor 3 can be designed as a fusible conductor strip and/or, preferably, as a fusible conductor wire with a circular and/or elliptical cross-section.

FIG. 2 illustrates that the end region 10 of the fusible conductor 2 is completely enclosed by the connecting means 11.

In further embodiments, which are not shown in detail, it may also be provided that the receptacle 8 is not completely filled with the connecting means 11 and/or that the end region 10 of the fusible conductor 2 is not completely enclosed by the connecting means 11, in particular such that at least one section of the end region 10 of the fusible conductor 2 protrudes from and/or opposite the connecting means 11.

The connecting means 11 is arranged exclusively in the region of the receptacle 8, as also shown in FIG. 6.

It is not shown in detail that the through-opening 9 has an opening width 24 of between 0.1 mm and 6 mm, preferably between 0.5 mm and 5 mm. The opening width 24 is shown, for example, in FIG. 6. The opening width 24 is particularly preferred to be between 1.1 and 1.5 mm.

FIG. 7 shows that the receptacle 8 is designed as a V-shaped through and as a truncated cone-shaped depression. In particular, the opening angle a, which is shown, for example, in FIG. 9 and corresponds in particular to twice the angle between the generatrix of the truncated cone and the cone axis, can be between 20° and 90°, in particular between 50° and 70°.

The truncated cone-shaped recess is characterised in that the two front sides (base surface and top surface (also referred to as the cut surface)) are open and the lateral surface is designed as a leg protruding from the bridging area 20.

FIG. 3 shows that the connecting means 11 located in the receptacle 8 rests directly against the inner wall 14 facing the inside 7 of the insulating body 2, in particular the inner wall 14 of the outer cap 6 resting on the open-front side of the insulating body 2.

FIG. 3 shows that the receptacle 8 is at least substantially completely filled with the connecting means 11.

It is not shown that in further embodiments the receptacle 8 can only be partially filled with the connecting means 11. The connecting means 11 is in particular designed in one piece. The connecting means 11 fills at least 20%, in particular at least 40%, of the volume of the receptacle 8.

The outer cap 6 can be connected to the auxiliary cap 4, for example, by means of a press fit and/or a crimp connection. In particular, the outer cap 6 is connected to the auxiliary cap 4 by means of at least one crimp connection, in particular by means of at least four crimp connections.

FIG. 14 shows that the auxiliary cap 4 has a sheath surface 15 surrounding the wall of the insulating body 2. The sheath surface 15 of the auxiliary cap 4 can be connected to the wall of the insulating body 2 by friction, as can also be seen in FIG. 5. In addition, FIG. 4 shows that the sheath surface 15 has at least one, preferably circumferential, end-protruding locking leg 16.

The locking leg 16 can be engaged by the outer cap 6, as can be seen in FIG. 3.

FIG. 2 shows that the outer cap 6 is designed to completely cover the front side 5 of the insulating body 2. The outer cap 6 comprises an outer sheath surface 17, which is also shown in FIG. 1. The outer sheath surface 17 can at least indirectly bear against the wall of the insulating body 2 and/or at least indirectly surround the wall of the insulating body 2. In the embodiment shown in FIG. 3, the sheath surface 15 of the auxiliary cap 4 is arranged between the wall of the insulating body 2 and the outer sheath surface 17. The outer sheath surface 17 can preferably be connected in a friction-locking manner to the sheath surface 15 of the auxiliary cap 4 and at least indirectly in a friction-locking manner to the wall of the insulating body 2.

The connecting means 11 used in the embodiments shown may comprise solder as a material and/or consist thereof. It is not shown that an electrically conductive adhesive, in particular silver conductive adhesive, can also be provided as the connecting means 11.

Furthermore, it is not shown that the connecting means 11 can also be formed by a sheath around the fusible conductor 3, in particular a sheath provided in the end region 10 of the fusible conductor 3. The sheathing may in particular be designed as a tin sheathing.

The connecting means 11 may be designed in wire form, as solder paste, as a pellet or as a moulded part before fusion. When solder is used as the connecting means 11, it is particularly preferred that the solder is lead-free.

FIG. 7 shows that the auxiliary cap 4 has a bridging area 20 connecting the sheath surface 15 to the receptacle 8. The sheath surface of the receptacle 8, in particular the sheath surface of the truncated cone-shaped recess, can also be connected to the bridging area 20. The bridging area 20 can also delimit a further opening 21. The further opening 21 can be opposite the through opening. The further opening 21 and the through opening 9 can form the front sides of the trough opening or the receptacle 8. The bridging area 20 can rest at least in some areas on the front side 5 of the wall and/of the insulating body 2, as shown in FIG. 3. The bridging area 20 can also protrude from the wall of the insulating body 2, in particular with the bridging area 20 protruding circumferentially relative to the wall of the insulating body 2.

The further opening 21 can also be designed to be at least essentially circular, as shown in FIG. 7. The area of the further opening 21 can span between 50% and 80% of the area of the open-front side 5 of the insulating body 2.

It is not shown in detail that the interior 7 of the insulating body 2 is at least partially filled with an extinguishing agent, in particular extinguishing sand.

It is also not shown in detail that the insulating bodies 2 are made of ceramic and/or plastic and/or consist of these materials.

As already explained at the beginning, the figures show that, in addition to the auxiliary cap 4, a further auxiliary cap 22 is provided, which is covered by a further outer cap 23. The additional auxiliary cap 22 and the additional outer cap 23 may be designed in accordance with the features previously discussed in connection with the auxiliary cap 4 and the outer cap 6. Thus, the additional auxiliary cap 22 may also be provided to cover at least part of the additional front side 5 of the insulating body 2. The further outer cap 23 can be electrically connected to the further auxiliary cap 22 and cover it, preferably completely.

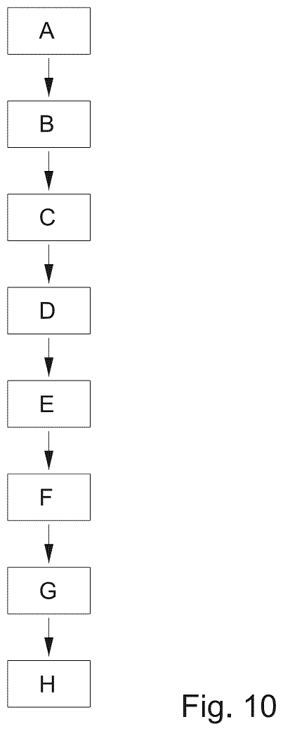

FIG. 10 shows a schematic process flow for manufacturing a fuse 1 that is designed according to one of the aforementioned embodiments. The process shown in FIG. 10 comprises steps A to H.

In step A, an insulating body 2, at least one auxiliary cap 4, at least one outer cap 6 and at least one fusible conductor 3 are provided. In the subsequent process step B, the auxiliary cap 4 is placed on a front side 5 of the insulating body 2.

Step C can be provided optionally and comprises placing a further auxiliary cap 22 on a further front side 5 of the insulating body 2.

After process step C, process step D is carried out. In step D, the fusible conductor 3 is inserted into the interior 7 of the insulating body 2. The fusible conductor 3 can be inserted through the through-opening 9 of the receptacle 8 of the auxiliary cap 4.

In process step E, the auxiliary cap 4 is connected to the fusible conductor 3 by arranging the connecting means 11 in the receptacle 8 of the auxiliary cap 4 to electrically connect the auxiliary cap 4 to the fusible conductor 3.

Steps F and G are optional. In step F, after step E has been carried out, the insulating body 2 is rotated, in particular by 100° to 200°, preferably by approximately 180°. In the optional process step G, an extinguishing agent is introduced, preferably via the front side 5 that is not yet covered and/or the further receptacle 8 of the further auxiliary cap 22 that is not yet filled with the connecting means 11. The extinguishing agent may be located inside 7 of the insulating body 2.

In process step H, the auxiliary cap 4 is covered with the outer cap 6 for electrical contact.

Not shown is that the further auxiliary cap 22, preferably after process step F and/or after process step G and/or H, is connected to the fusible conductor 3 via the connecting means 11 in the further receptacle 8 of the further auxiliary cap 22 for electrical connection of the further auxiliary cap 22 to the fusible conductor 3, in particular, the further auxiliary cap 22 being covered with a further outer cap 23 for electrical contacting.

Furthermore, it is not shown that the connecting means 11 can be heated after being arranged in the receptacle 8. The heating can be effected in particular by melting the connecting means 11. Such a heating step can be carried out in particular by means of a flame, resistance soldering, laser soldering, hot air and/or induction. Alternatively or additionally, it may be provided that the connecting means 11 is designed in wire form, as solder paste, as a pellet and as a moulded part before heating and/or before melting. Ultimately, the connecting means 11 can be provided in different forms and a permanent bond with the end region 10 of the fusible conductor 3 can be achieved by melting and/or liquefying the connecting means 11.

### LIST OF REFERENCE SIGNS

1 Fuse
2 Insulating body
3 Fusible conductor
4 Auxiliary cap
5 Front side of 2
6 Outer cap
7 Interior of 2
8 Receptacle of 4
9 Through-opening
10 End region of 3
11 Connecting means
12 Length of 3
13 Length of 2
14 Inner wall of 6
15 Sheath surface of 4
16 Locking leg
17 Outer surface
18 Length of 10
19 Depth of 8
20 Bridging area
21 Further opening
22 Additional auxiliary cap
23 Additional outer cap
24 Opening width
8 Opening angle

1. A fuse comprising:
an insulating body open at the front;
at least one fusible conductor arranged in the insulating body;
at least one auxiliary cap connected to the fusible conductor in such a way as to make electrical contact with the fusible conductor, for covering at least part of the front side of the insulating body; and
an outer cap assigned to the auxiliary cap, covering the latter at least in part, and connected to the auxiliary cap in such a way as to make electrical contact with the outer cap;
wherein the auxiliary cap has a receptacle projecting into the interior of the insulating body with a through-opening projecting into the interior of the insulating body, through which the end region of the fusible conductor is passed;
wherein the end region of the fusible conductor is connected in an electrically conductive manner to the auxiliary cap via a connecting means arranged in the receptacle;
wherein the outer cap covers the auxiliary cap in such a way that the connecting means is trapped and/or encapsulated between the auxiliary cap and the outer cap;
wherein the connecting means is arranged exclusively in the region of the receptacle;
wherein the through-opening has an opening width between 0.1 mm and 6 mm;
wherein the receptacle is formed as a truncated cone-shaped recess, wherein the opening angle of the recess formed as a truncated cone is between 10° and 100°, wherein the opening angle ensures a trough enlarging the opening width of the through-opening towards the end face of the insulating body;
wherein the trough tapers towards the interior of the insulating body so that the connecting means is arranged exclusively in the region of the receptacle; and
wherein the fusible conductor is arranged without contact with the outer cap and the auxiliary cap.

2. The fuse according to claim 1, wherein the fusible conductor ends in the receptacle inside the insulating body.

3. The fuse according to claim 1, wherein the through-opening has an opening width between 0.5 mm and 5 mm.

4. The fuse according to claim 1, wherein the opening angle (α) of the receptacle designed as a truncated cone-shaped recess is between 20° and 90°.

5. The fuse according to claim 1, wherein the connecting means located in the receptacle rests directly against the inner wall of the outer cap facing the interior of the insulating body.

6. The fuse according to claim 1, wherein the receptacle is at least substantially completely filled with the connecting means.

7. The fuse according to claim 1, wherein the outer cap is connected to the auxiliary cap by at least one crimp connection.

8. The fuse according to claim 1, wherein the auxiliary cap has a sheath surface surrounding the wall of the insulating body.

9. The fuse according to claim 1, wherein the connecting means comprises solder and/or an electrically conductive adhesive, and/or wherein the connecting means is lead-free.

10. The fuse according to claim 1, wherein the auxiliary cap has a bridging area connecting the sheath surface to the receptacle.

11. The fuse according to claim 1, wherein the receptacle opposite the through-opening projecting into the interior of the insulating body has a further opening.

12. The fuse according to claim 1, wherein the interior of the insulating body is at least partially filled with an extinguishing agent.

13. The fuse according to claim 1, wherein a further auxiliary cap is connected in contact with the fusible conductor to at least partially cover the further front side of the insulating body and a further outer cap associated with the further auxiliary cap and covering the latter at least partially, and electrically contacting the further auxiliary cap is provided.

14-16. (canceled)

17. The fuse according to claim 1, wherein the fuse is a surface mounted device (SMD) fuse.

18. The fuse according to claim 1, wherein the connecting means is a lead-free connecting means.

19. The fuse according to claim 3, wherein the opening width of the through-opening is between 1.1 mm and 1.5 mm.

20. The fuse according to claim 12, wherein the extinguishing agent is extinguishing sand.
